(19) United States
(12) Patent Application Publication
(10) Pub. No.: US 2026/0096649 A1
(43) Pub. Date: Apr. 9, 2026

(54) Art Supply Storage Rack and Method

(71) Applicant: Jerry's Artarama N.C., Inc., Raleigh, NC (US)

(72) Inventor: Heather Bankston, Raleigh, NC (US)

(73) Assignee: Jerry's Artarama N.C., Inc., Raleigh, NC (US)

(21) Appl. No.: 19/286,559

(22) Filed: Jul. 31, 2025

Related U.S. Application Data
(60) Provisional application No. 63/705,139, filed on Oct. 9, 2024.

(51) Int. Cl. A47B 47/04; A47B 81/00; B44D 3/04; B44D 3/12

(52) U.S. Cl. CPC A47B 47/042; A47B 81/00; B44D 3/04; B44D 3/125

(57) ABSTRACT

An art supply storage rack. The rack may include two side panels and a back panel, the side panels and back panel may have tabs and slots therein, the tabs of the side panels may insert into corresponding slots formed in the tabs of the back panel to form a frame; a bottom tray having spaced slots therein and tabs extending outward from opposing side edges and rear edge; a middle tray having spaced openings and tabs extending outward from opposing side edges and rear edge, the middle tray positioned above the bottom tray; a first upper tray having spaced openings and tabs extending outward from opposing side edges and rear edge, the first upper tray positioned above the middle tray; the outwardly extending tabs of each of the bottom tray, middle tray, and first upper shelf may insert into certain slots of the side panels and back panel to form a rack, and the bottom tray may be positioned above a lower most edge of the support frame forming a gap between the bottom tray and surface upon which the rack is resting on.

### RELATED APPLICATIONS

This application is related and claims priority to U.S. Provisional Patent Application No. 63/705,139, filed on Oct. 9, 2024, the application of which is incorporate herein by reference in its entirety.

### TECHNICAL FIELD

The subject matter relates generally to equipment for art supplies and more particularly to an art supply storage rack and method.

### BACKGROUND

For centuries artists have struggled to organize their supplies including paint and paintbrushes. Organization of brushes ranges from nonexistent when brushes are merely dropped on a tabletop to the usual deposition bristle end up in a cup or similar container. Paint tubes are also generally strewn on a surface or piled into a box. The foregoing arrangements are suboptimal as time is wasted looking for a particular brush or paint color. Additionally, contamination between colors and mediums can ruin expensive paint. Accordingly, it may be beneficial to provide a way to organize an artist's paint supplies and/or equipment with the added benefit of enhancing the artist's productivity and reducing waste.

### SUMMARY

In one embodiment, an art supply storage rack is provided. The art supply storage rack may include a first vertical side panel, a second vertical side panel, and a vertical back panel, the first vertical side panel, second vertical side panel, and vertical back panel may have one or more tabs and a plurality of slots therein, wherein the tabs of the first vertical side panel, second vertical side panel may be configured to insert into corresponding slots of the vertical back panel to define a support frame; a bottom horizontal tray having a plurality of tabs extending outward from opposing side edges and rear edge thereof; a middle horizontal tray having a plurality of spaced openings therethrough and tabs extending outward from opposing side edges and rear edge thereof, the middle horizontal tray configured to be positioned vertically spaced apart from and above the bottom horizontal tray; a first upper horizontal tray having a plurality of spaced openings therethrough and tabs extending outward from opposing side edges and rear edge thereof, the first upper horizontal tray configured to be positioned vertically spaced apart from and above the middle horizontal tray; and wherein, the outwardly extending tabs of each of the bottom horizontal tray, middle horizontal tray, and first upper horizontal shelf may be configured to insert into corresponding ones of the slots of the first vertical side panel, second vertical side panel, and vertical back panel to form a rack, and wherein the bottom horizontal tray may be configured to be positioned above a bottom of the support frame thereby forming a gap between a bottom surface of the bottom horizontal tray and a surface upon which the rack is set upon. A portion of the middle horizontal tray may be configured to extend underneath the first upper horizontal shelf. The art supply storage rack may further include a utility tray having tabs extending outward from opposing side edges thereof, wherein the tabs may be configured to engage with an upper notch of each of the first vertical side panel and the second vertical side panel. The utility tray may be positionable parallel with and within the same horizontal plane as the first upper horizontal shelf. The utility tray further may include a magnetic plate disposed on a surface thereof. The art supply storage rack may further include a drip tray, wherein the drip tray may be configured to be positionable at a front of and/or at least partially within the gap formed below the bottom surface of the bottom horizontal tray. The utility tray may be configured to be installed on the drip tray, wherein the drip tray may include end notches formed in an upper rim surface of each end wall of the drip tray, and wherein the tabs of the utility tray may be configured to be received by corresponding ones of the end notches of the drip tray. The drip tray may further include side notches formed in each of an upper and lower edge of a portion of each of a front side and a rear side of the drip tray, wherein the side notches may be configure to receive a band, and wherein when installed the band is configured to secure the utility tray to the drip tray. The utility tray with the drip tray secured thereto may be configured to be received by the upper notches of each of the first vertical side panel and the second vertical side panel via overhanging portions of the tabs extending outward from opposing side edges of the utility tray and drip tray. The art supply storage rack may further include a removable paint well tray, the paint well tray may include a plurality of paint wells. The middle horizontal tray may be configured to receive the paint well tray. Certain ones of the spaced openings of the middle horizontal tray may be configured to receive well portions of the paint wells of the paint well tray therein. At least one elastic band may surround a portion of at least one respective tab that extends through the slot it is inserted into to secure the frame and/or rack in place. One or more of the spaced openings of the middle horizontal tray and first upper horizontal shelf may be configured to receive at least one or more of paint tubes and paintbrushes. The bottom horizontal tray may include a plurality of spaced slots therein, and wherein one or more of the spaced openings may be positioned and configured such that a sealed end of a paint tube is guided toward one of the slots of the bottom horizontal tray when the paint tube is inserted therein. One or more of the spaced openings may be different sizes of one or more of other spaced openings to accommodate variously sized paint tubes and/or paintbrushes. The art supply storage rack may further include a second upper horizontal shelf having a plurality of spaced openings therethrough and tabs extending outward from opposing side edges and rear edge thereof, the second upper horizontal tray configured to be positioned vertically spaced apart from and above the middle horizontal tray and below the first upper horizontal tray wherein, the outwardly extending tabs of the second upper horizontal shelf may be configured to insert into slots of the first vertical side panel, second vertical side panel, and vertical back panel. One or more of the spaced openings of the middle horizontal tray, first upper horizontal shelf, and second upper horizontal shelf may be configured to receive at least one or more of paint tubes and paintbrushes. One or more of the spaced openings of the second horizontal tray may mirror respective ones of one or more of the spaced openings of the first upper horizontal shelf. One or more of the spaced openings may be different sizes of one or more of other spaced openings to accommodate variously sized paint tubes and/or paintbrushes.

In another embodiment, a method of using an art supply storage rack is provided. The method may include providing the art supply storage rack. The art supply storage rack may include a first vertical side panel, a second vertical side panel, and a vertical back panel, the first vertical side panel, second vertical side panel, and vertical back panel may have one or more tabs and a plurality of slots therein, wherein the tabs of the first vertical side panel, second vertical side panel may be configured to insert into corresponding slots of the vertical back panel to define a support frame; a bottom horizontal tray having a plurality of tabs extending outward from opposing side edges and rear edge thereof; a middle horizontal tray having a plurality of spaced openings therethrough and tabs extending outward from opposing side edges and rear edge thereof, the middle horizontal tray configured to be positioned vertically spaced apart from and above the bottom horizontal tray; a first upper horizontal tray having a plurality of spaced openings therethrough and tabs extending outward from opposing side edges and rear edge thereof, the first upper horizontal tray configured to be positioned vertically spaced apart from and above the middle horizontal tray; and wherein, the outwardly extending tabs of each of the bottom horizontal tray, middle horizontal tray, and first upper horizontal shelf may be configured to insert into corresponding ones of the slots of the first vertical side panel, second vertical side panel, and vertical back panel to form a rack, and wherein the bottom horizontal tray may be configured to be positioned above a bottom of the support frame thereby forming a gap between a bottom surface of the bottom horizontal tray and a surface upon which the rack is set upon. The method may further include configuring the art supply storage rack for use; stocking the art supply storage rack with desired art supplies to conduct an art activity; and optionally, at a conclusion of the art activity, configuring the art supply storage rack to a storage or travel configuration.

### BRIEF DESCRIPTION OF THE DRAWINGS

Having thus described the subject matter in general terms, reference will now be made to the accompanying drawings, which are not necessarily drawn to scale, and wherein:

FIG. 1 illustrates a perspective view of an example of an art supply storage rack, in accordance with an embodiment of the invention;

FIG. 2 illustrates an exploded view of the art supply storage rack shown in FIG. 1;

FIG. 3 illustrates a perspective view of an example of the art supply storage rack shown in FIG. 1 and FIG. 2 populated with supplies, in accordance with an embodiment of the invention;

FIG. 4A through FIG. 8B illustrate perspective views of an example of a process of assembling the main structure of the art supply storage rack shown in FIG. 1;

FIG. 9 illustrates a perspective view showing more details of coupling the panels of the art supply storage rack shown in FIG. 1;

FIG. 10, FIG. 11, FIG. 12, FIG. 13, FIG. 14, and FIG. 15 illustrate a top view, a bottom view, a front view, a back view, a first side view, and a second side view, respectively, of the art supply storage rack shown in FIG. 1;

FIG. 16 illustrates a perspective view of an example of the art supply storage rack in a “travel” or “storage” configuration, in accordance with an embodiment of the invention;

FIG. 17 and FIG. 18 illustrate a perspective view and a plan view, respectively, of an example of a side panel of the art supply storage rack shown in FIG. 1;

FIG. 19 and FIG. 20 illustrate a perspective view and a plan view, respectively, of an example of a back panel of the art supply storage rack shown in FIG. 1;

FIG. 21 and FIG. 22 illustrate a perspective view and a plan view, respectively, of an example of a bottom tray of the art supply storage rack shown in FIG. 1;

FIG. 23 and FIG. 24 illustrate a perspective view and a plan view, respectively, of an example of a middle tray of the art supply storage rack shown in FIG. 1;

FIG. 25 and FIG. 26 illustrate a perspective view and a plan view, respectively, of an example of an upper shelf of the art supply storage rack shown in FIG. 1;

FIG. 27 and FIG. 28 illustrate an exploded view and an assembled view, respectively, of an example of a utility tray and a magnetic plate of the art supply storage rack shown in FIG. 1;

FIG. 29 illustrates a perspective view of an example of a paint well tray of the art supply storage rack shown in FIG. 1;

FIG. 30, FIG. 31, FIG. 32, FIG. 33, FIG. 34, and FIG. 35 illustrate a top view, a bottom view, a first end view, a second end view, a first side view, and a second side view, respectively, of the paint well tray shown in FIG. 29;

FIG. 36 illustrates a perspective view of an example of a drip tray of the art supply storage rack shown in FIG. 1 and FIG. 37;

FIG. 37 illustrates a perspective view of an example of the utility tray and the drip tray of the art supply storage rack shown in FIG. 1 in a “travel” or “storage” configuration;

FIG. 38 illustrates a side view of an example of the utility tray and the drip tray of the art supply storage rack shown in FIG. 1 in a “travel”or “storage”configuration;

FIG. 39 illustrates an end view of an example of the utility tray and the drip tray of the art supply storage rack shown in FIG. 1 in a “travel”or “storage”configuration;

FIG. 40 illustrates a cross-sectional-view along line A-A of FIG. 37 of an example of the utility tray and the drip tray of the art supply storage rack shown in FIG. 1 in a “travel” or “storage” configuration; and

FIG. 41 illustrates a flow diagram of an example of a method of using the art supply storage rack shown in FIG. 1 through FIG. 40, in accordance with an embodiment of the invention.

### DETAILED DESCRIPTION

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure will satisfy applicable legal requirements. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides an art supply storage rack and method.

In some embodiments, the art supply storage rack and method provide a means of easily organizing an artist's paint supplies and/or equipment and thereby enhancing the artist's productivity and reducing waste.

In some embodiments, the art supply storage rack and method provide a rack structure including a pair of side panels, a back panel, a horizontal bottom tray, a horizontal middle tray, a pair of upper shelves, a utility tray with an optional magnetic plate, a drip tray, and a paint well tray and wherein the paint well tray provides a multi-well tray for holding an assortment of paint, such as watercolor, of various different colors.

In some embodiments, the art supply storage rack and method provide a rack structure including a pair of side panels, a back panel, a horizontal bottom tray, a horizontal middle tray, and a pair of upper shelves all assembled using a slot/tab/elastic band system.

In some embodiments, the art supply storage rack and method provide both a “travel” or “storage” configuration and an “in use” configuration and wherein it is easy to convert from one configuration to the other.

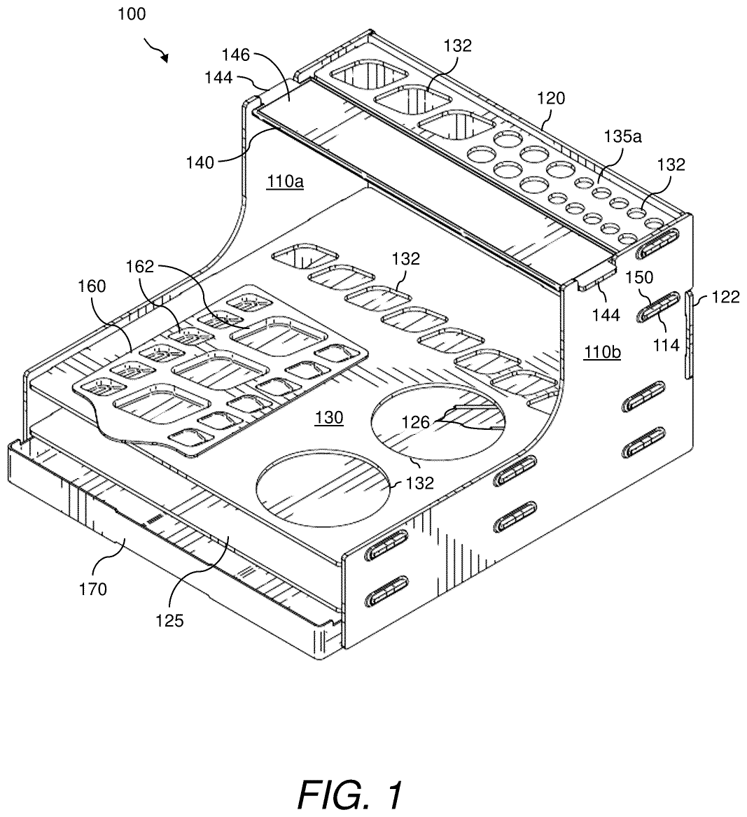

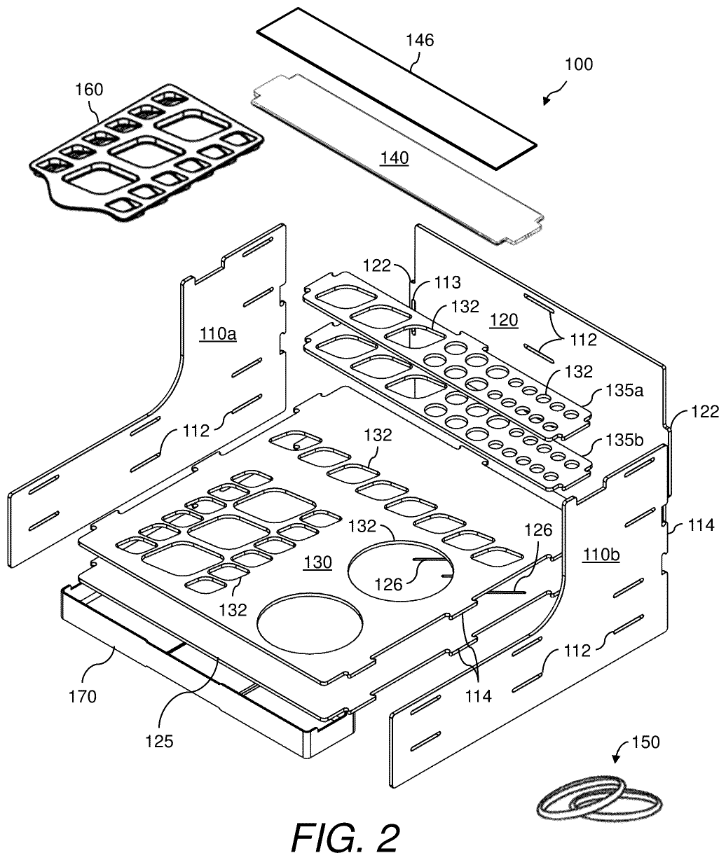

Referring now to FIG. 1 is a perspective view of an example of an art supply storage rack 100 in a state that is ready for use, in accordance with an embodiment of the invention. Further, FIG. 2 is an exploded view of the art supply storage rack 100 shown in FIG. 1. Referring still to FIG. 1 and FIG. 2, art supply storage rack 100 may be provided for holding a paint well tray 160 along with various paint supplies, such as, but not limited to, various containers, paint brushes, paint tubes, markers, highlighters, and the like. The paint well tray 160 provides a multi-well rack for holding an assortment of paint, such as watercolors, of various different colors. Generally, art supply storage rack 100 provides a way of holding a supply of paint and various paint supplies and/or tools in an organized fashion.

The main structure of the art supply storage rack 100 may include a pair of side panels 110 (e.g., side panels 110a, 110b) coupled to a back panel 120. Additionally, each of the side panels 110 may include an arrangement of horizontal slots 112 and an outwardly projecting tab 114 (i.e., a band receiving tab) along a rear edge thereof. The back panel 120 also includes an arrangement of horizontal slots 112 and a tab 122 on each side. Each of the tabs 122 has a vertical slot 113. The art supply storage rack 100 may also include a horizontal bottom tray 125, a horizontal middle tray 130, and a pair of upper shelves 135 (e.g., stacked upper shelves 135a, 135b). The horizontal bottom tray 125 may have an arrangement of slots 126. The horizontal middle tray 130 may have an arrangement of openings 132. Each of the upper shelves 135 also may have an arrangement of openings 132. In the horizontal middle tray 130 and the upper shelves 135, the openings 132 can vary in shape, size, location, and/or number. Together, the side panels 110a, 110b, the back panel 120, the horizontal bottom tray 125, the horizontal middle tray 130, and the upper shelves 135a, 135b may provide the main structure of the art supply storage rack 100.

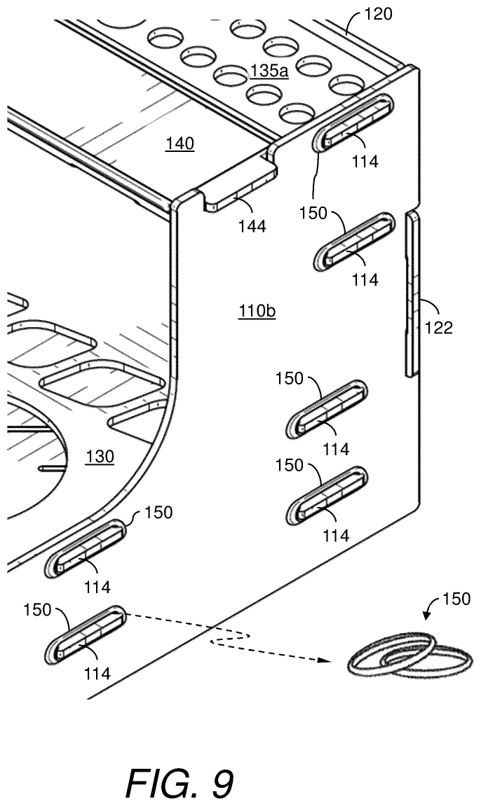

The projecting tabs 114 are designed to pass through respective slots 112 or slots 113. Then, an elastic band 150 may be installed around each of the projecting tabs 114. Accordingly, the elastic bands 150 provide a connection means to hold the panels of the art supply storage rack 100 together. More details of using the elastic bands 150 to hold the panels of the art supply storage rack 100 together are shown in FIG. 9.

The art supply storage rack 100 is designed to hold various types of paint supplies and/or tools. As mentioned above, the art supply storage rack 100 may hold the paint well tray 160, which is a multi-well rack for holding an assortment of paint. For example, the paint well tray 160 may sit atop and/or in the horizontal middle tray 130. Accordingly, certain openings 132 of the horizontal middle tray 130 may be specific for receiving the paint well tray 160.

The art supply storage rack 100 may also include a utility tray 140. Optionally, utility tray 140 may hold a magnetic plate 146 for reliably securing any types of metal objects (i.e., any magnetically responsive objects) to the art supply storage rack 100. In one example, the utility tray 140 may be provided near the uppermost upper shelf 135 (e.g., near upper shelf 135a). The art supply storage rack 100 may also include a drip tray 170 positionable near the front of and/or below the horizontal bottom tray 125.

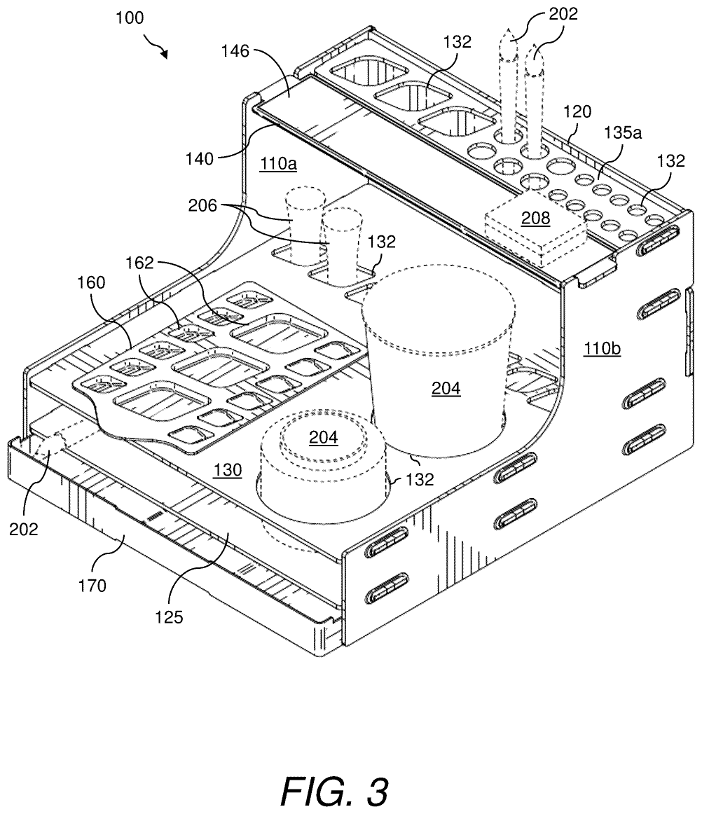

Referring now to FIG. 3 is a perspective view of an example of the art supply storage rack 100 shown in FIG. 1 and FIG. 2 populated with supplies and ready for use, in accordance with an embodiment of the invention. Here, the paint well tray 160 may include an arrangement of reservoirs or compartments 162 for holding paint. Again, the paint well tray 160 sits atop the horizontal middle tray 130. Further, certain openings 132 of the upper shelves 135a, 135b may be used to hold any number of paint brushes 202. Further, another paint brush 202 may be sitting atop the horizontal bottom tray 125. Further, certain openings 132 of the horizontal middle tray 130 may be used to hold cylindrical containers 204 (e.g., cups, bottles) that may be holding any types of liquids. Further, certain openings 132 of the horizontal middle tray 130 may be used to hold any number of paint tubes, markers, and/or highlighters 206. Further, a metal box/tray 208 may be magnetically held atop the utility tray 140 using the magnetic plate 146.

Referring still to FIG. 3, the drip tray 170 lays below/partially below the horizontal bottom tray 125, which is the bottommost tier, to collect any water/paint drips from wet brushes that are laid on below the horizontal bottom tray 125. Further, the optional magnetic plate 146 of the utility tray 140 provides a removable metal tier for magnetic paint (e.g., watercolor) pans (e.g., metal box 208). FIG. 1 and FIG. 3 show an “in use” configuration of the art supply storage rack 100 with the metal tier (e.g., the magnetic plate 146 on utility tray 140) on the art supply storage rack 100 and the drip tray 170 at the bottom.

The art supply storage rack 100 may be fabricated from any material that is structurally able to support any of the art supplies contemplated herein. In one example, the two side panels 110, the back panel 120, the horizontal bottom tray 125, the horizontal middle tray 130, and the two upper shelves 135 of the art supply storage rack 100 may be formed of a laminate wood product that may be in the range of about 0.125 inches to about 0.25 inches thick. In another example, the panels of the art supply storage rack 100 may be formed of plastics, such as Nylon® or Polyester®, or any other suitable material. The thickness of the rack panels may easily be adjusted in proportion to the size of the art supplies to be supported by the rack. It is contemplated that the panels of the art supply storage rack 100 will be produced by die stamping. Alternatively, the panels may be produced by molding or any other suitable technique/process.

In yet other examples, the panels of the art supply storage rack 100 may be formed of a cardboard-, paper-, and/or paperboard-based product, such as, but not limited to, corrugated cardboard, paperboard, post-consumer paperboard (i.e., recycled materials), polystyrene foam (e.g., Styrofoam), molded fiber, and the like.

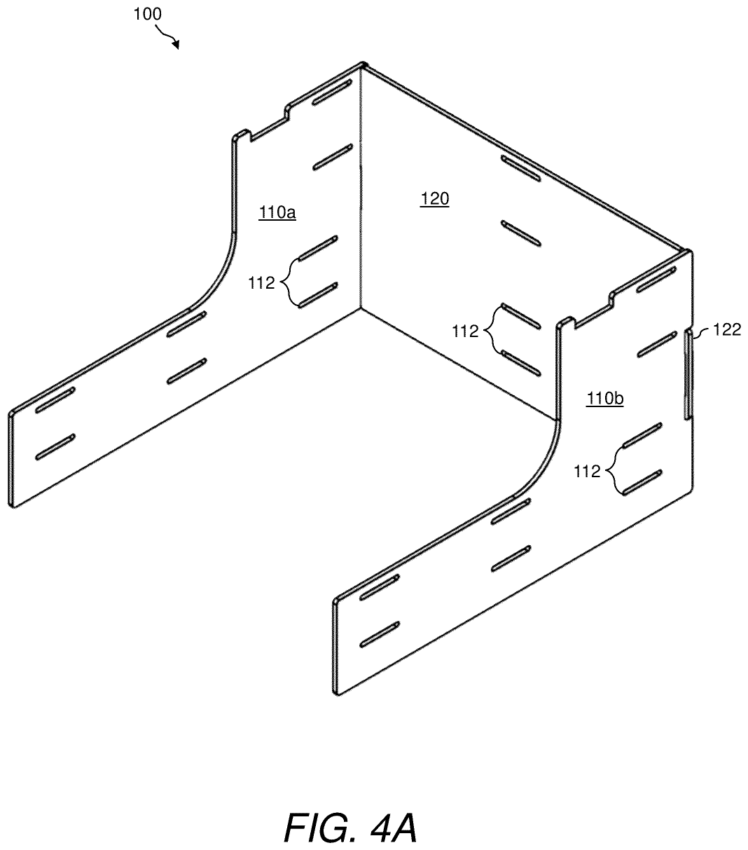

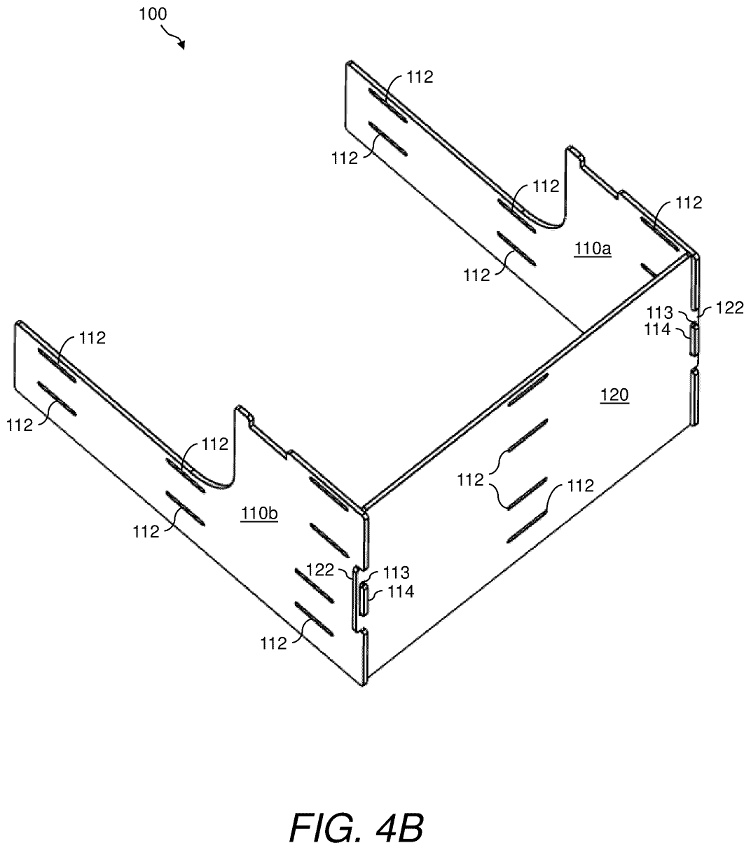

Referring now to FIG. 4A through FIG. 8B are perspective views of an example of a process of assembling the main structure of the art supply storage rack 100 shown in FIG. 1. In this example, FIG. 4A and FIG. 4B show front and back perspective views of the two side panels 110 coupled to the back panel 120. That is, the projecting tab 114 of the side panel 110a may be inserted through one vertical slot 113 of the back panel 120. Likewise, the projecting tab 114 of the side panel 110b may be inserted through the other vertical slot 113 of the back panel 120. Then, an elastic band 150 (not shown) may be installed around each of the two projecting tabs 114.

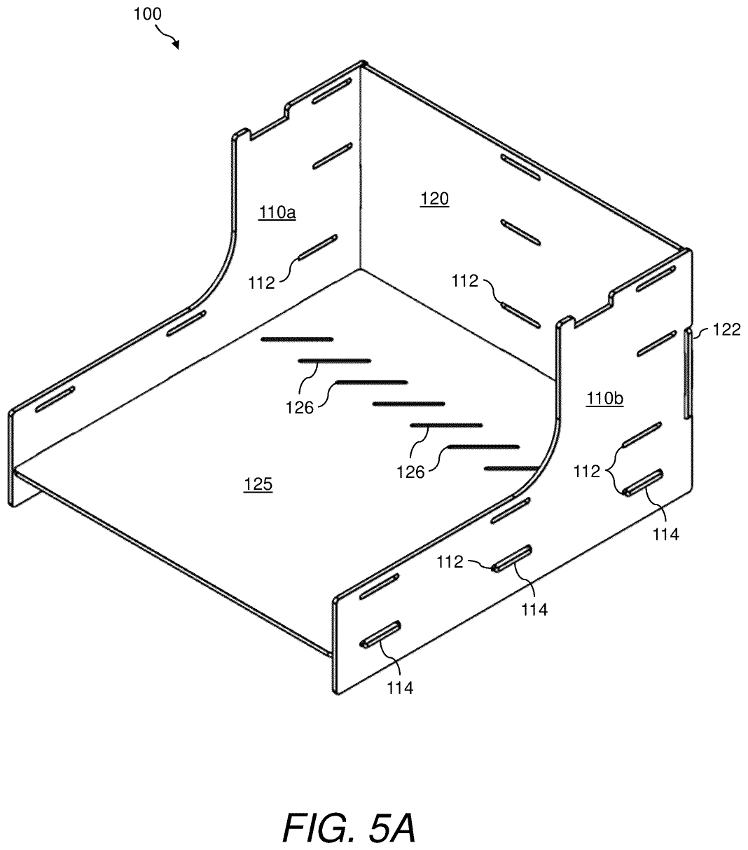

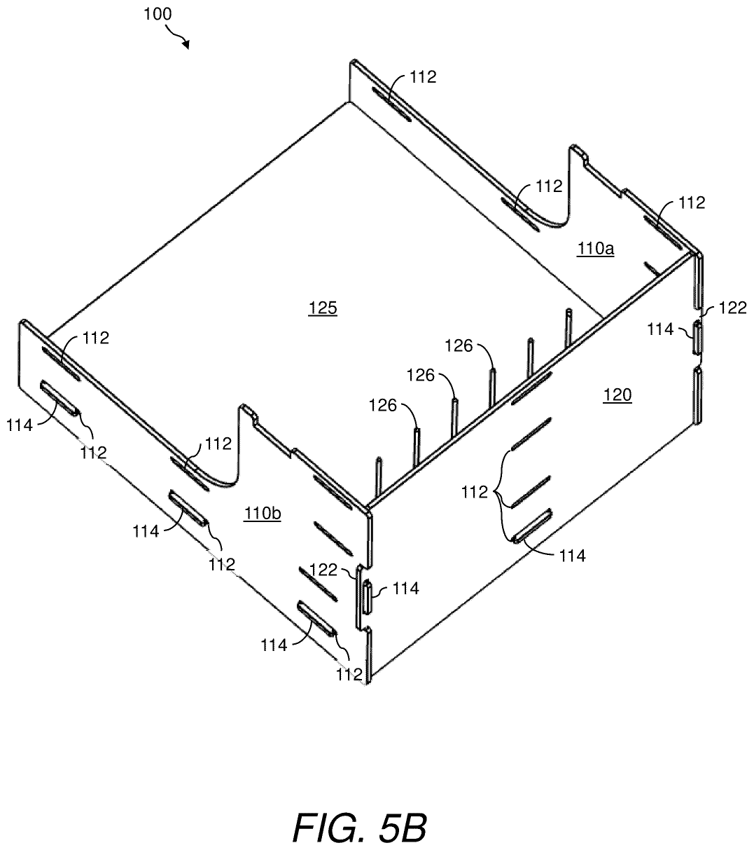

FIG. 5A and FIG. 5B show front and back perspective views of the horizontal bottom tray 125 coupled to the two side panels 110 and to the back panel 120. Here, the projecting tabs 114 of the horizontal bottom tray 125 may be inserted through the horizontal slots 112 of the two side panels 110 and the back panel 120. Then, an elastic band 150 (not shown) may be installed around each of the projecting tabs 114.

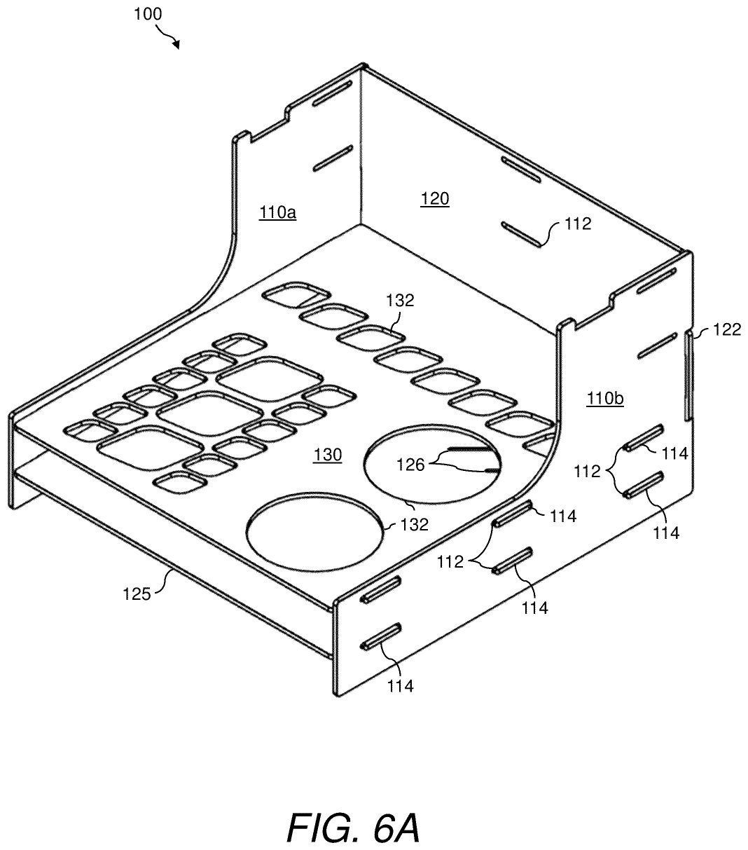

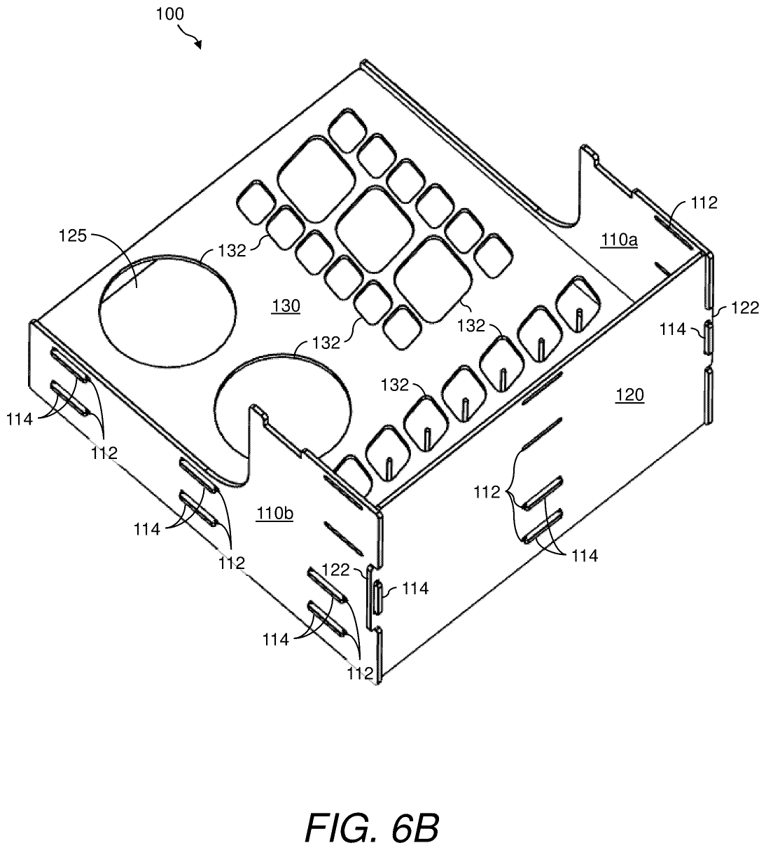

FIG. 6A and FIG. 6B show front and back perspective views of the horizontal middle tray 130 coupled to the two side panels 110 and to the back panel 120. Here, the projecting tabs 114 of the horizontal middle tray 130 may be inserted through the horizontal slots 112 of the two side panels 110 and the back panel 120. Then, an elastic band 150 (not shown) may be installed around each of the projecting tabs 114.

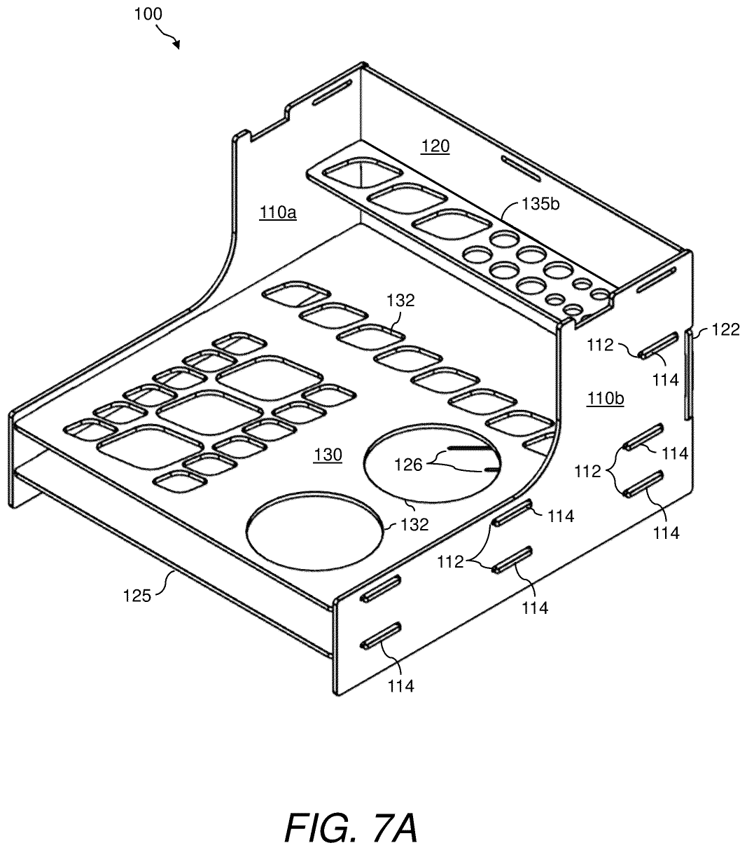

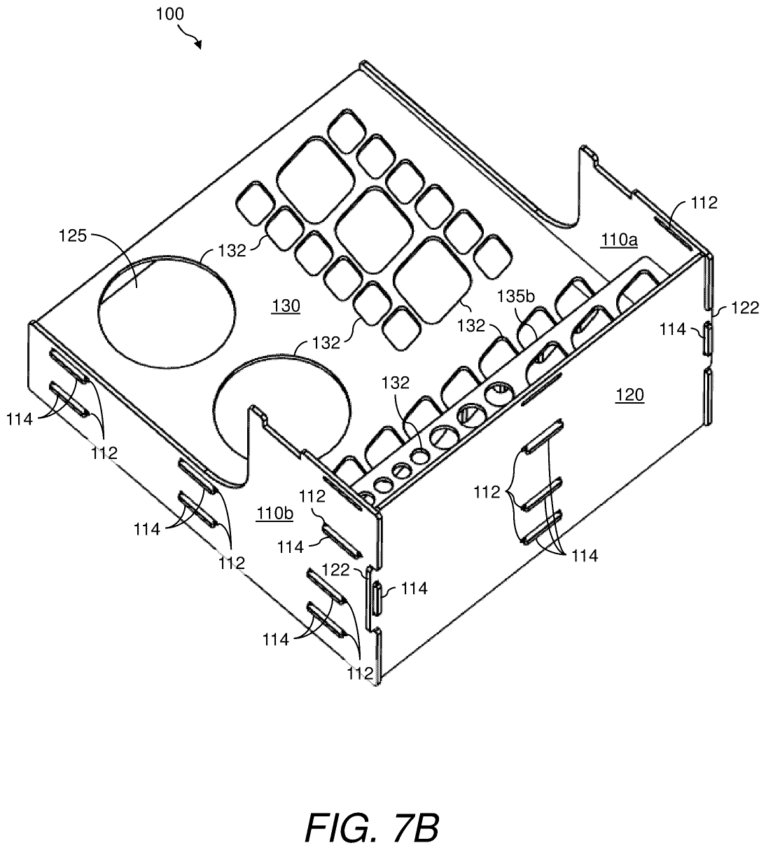

FIG. 7A and FIG. 7B show front and back perspective views of the upper shelf 135b coupled to the two side panels 110 and to the back panel 120. Here, the projecting tabs 114 of the upper shelf 135b may be inserted through the horizontal slots 112 of the two side panels 110 and the back panel 120. Then, an elastic band 150 (not shown) may be installed around each of the projecting tabs 114.

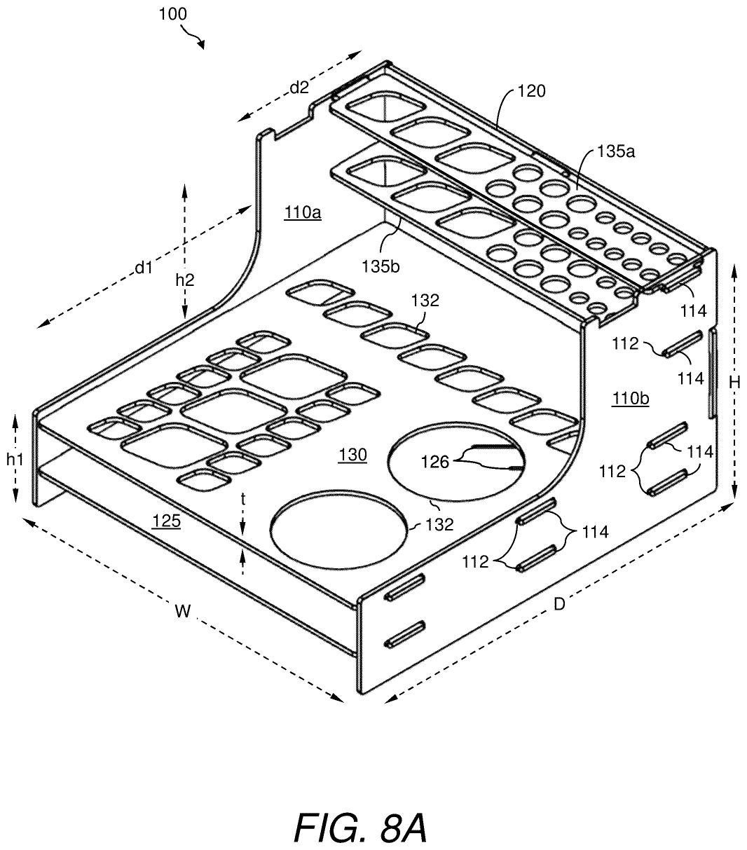

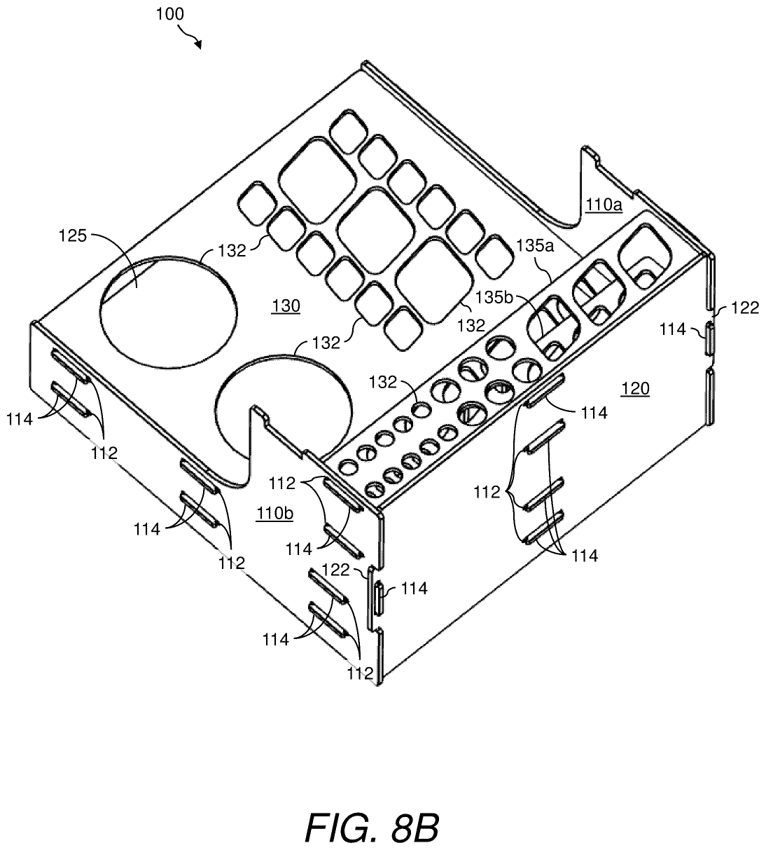

FIG. 8A and FIG. 8B show front and back perspective views of the upper shelf 135a coupled to the two side panels 110 and to the back panel 120. Here, the projecting tabs 114 of the upper shelf 135a may be inserted through the horizontal slots 112 of the two side panels 110 and the back panel 120. Then, an elastic band 150 (not shown) may be installed around each of the projecting tabs 114.

By way of example, FIG. 9 is a perspective view of a portion of the art supply storage rack 100 that shows how the elastic bands 150 may be installed around each of the projecting tabs 114. That is, the elastic bands 150 are used to secure the projecting tabs 114 within their respective horizontal slots 112 and/or vertical slots 113. Accordingly, the art supply storage rack 100 may be assembled/held together using a slot/tab/elastic band system. Here, the art supply storage rack 100 provides an arrangement of horizontal slots 112 and vertical slots 113 for receiving a corresponding arrangement of projecting tabs 114 that may be secured using elastic bands 150.

Referring now again to FIG. 8A, the art supply storage rack 100 has an overall width W, an overall depth D, and an overall height H. The art supply storage rack 100 has a lower main portion that may include horizontal bottom tray 125 and the horizontal middle tray 130. Further, the art supply storage rack 100 has a rear shelf portion that may include upper shelves 135A and 135b. The rear shelf portion is like a step up from the lower main portion. The lower main portion has a height h1 and a depth d1. The rear shelf portion has a height h2 and a depth d2. Further, each of the panels of the art supply storage rack 100 has a thickness t.

Generally, the sum of the height h1 of the lower main portion and the height h2 of the rear shelf portion substantially equals the overall height H of the art supply storage rack 100. Likewise, the sum of the depth d1 of the lower main portion and the depth d2 of the rear shelf portion equals the overall depth D of the art supply storage rack 100.

In one non-limiting example, the art supply storage rack 100 may have an overall width W of about 11 inches, an overall depth D of about 12 inches, and an overall height H of about 7 inches. Further, the lower main portion of the art supply storage rack 100 may have a height h1 of about 2.75 inches and a depth d1 of about 7.5 inches. Further, the rear shelf portion of the art supply storage rack 100 may have a height h2 of about 4.25 inches and a depth d2 of about 4.5 inches. Further, the panels of the art supply storage rack 100 may have a thickness t in the range of about 0.125 inches to about 0.25 inches. It is understood that these are only example dimensions, and the actual dimensions may be more or less than the examples herein.

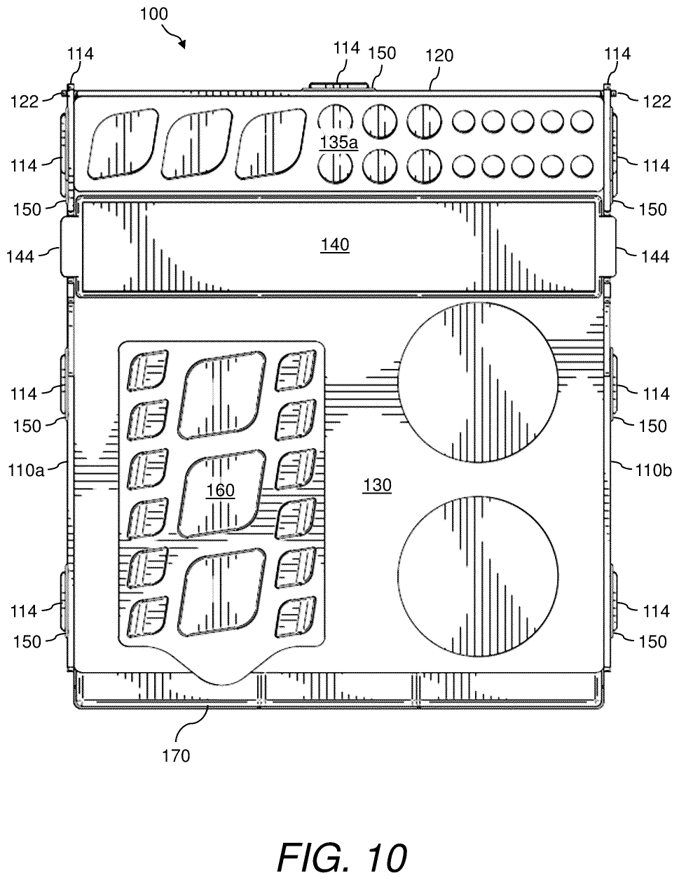

Referring now to FIG. 10, FIG. 11, FIG. 12, FIG. 13, FIG. 14, and FIG. 15 is a top view, a bottom view, a front view, a back view, a first side view, and a second side view, respectively, of the art supply storage rack 100 shown in FIG. 1.

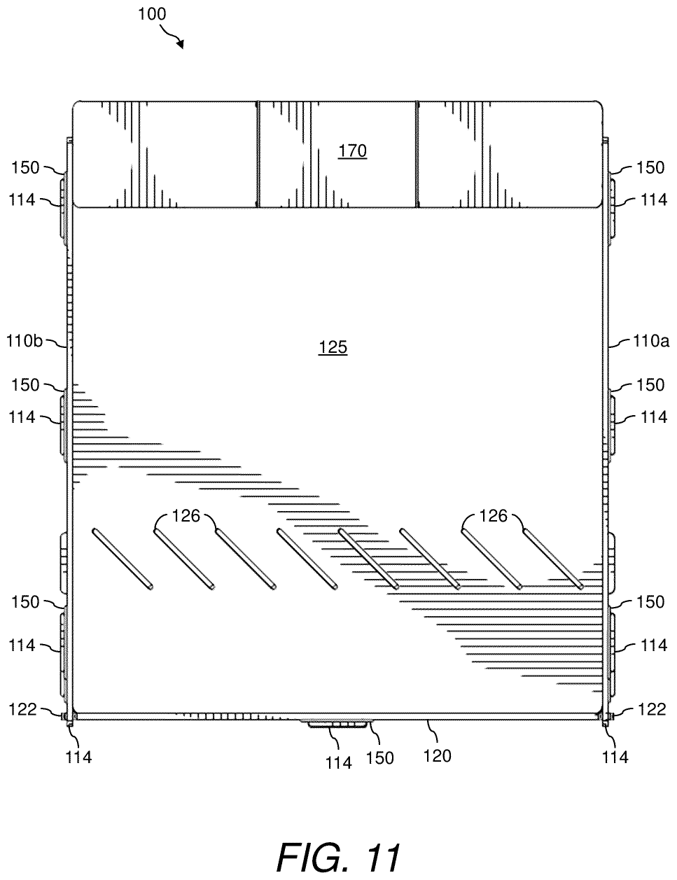

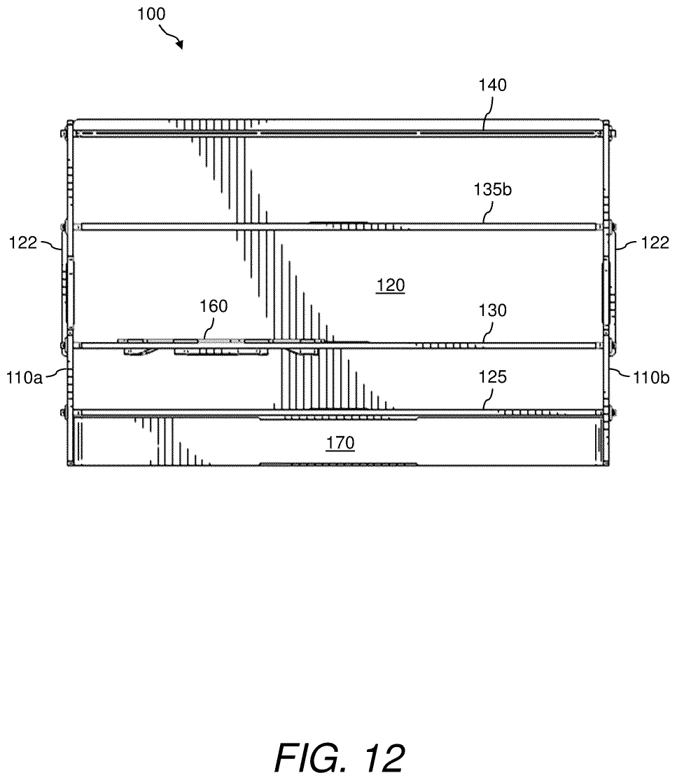

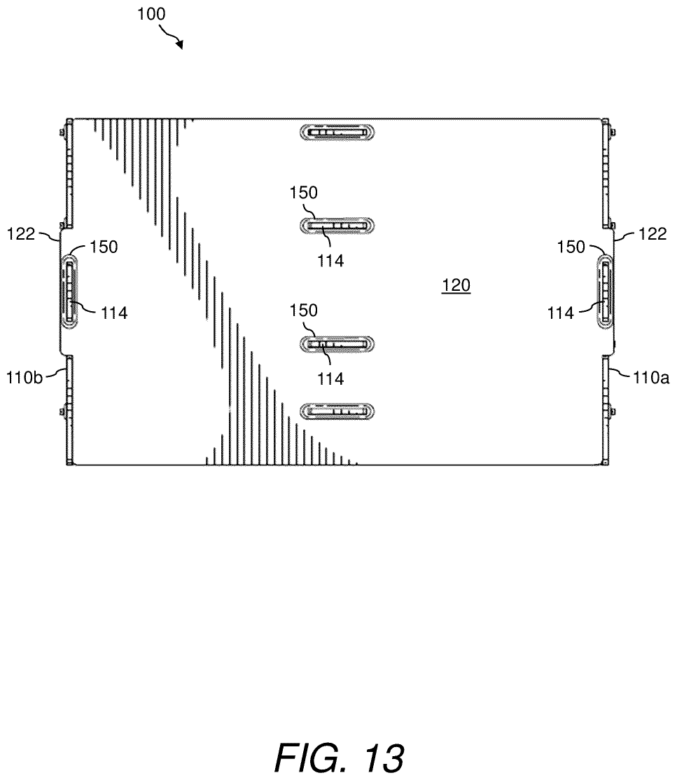

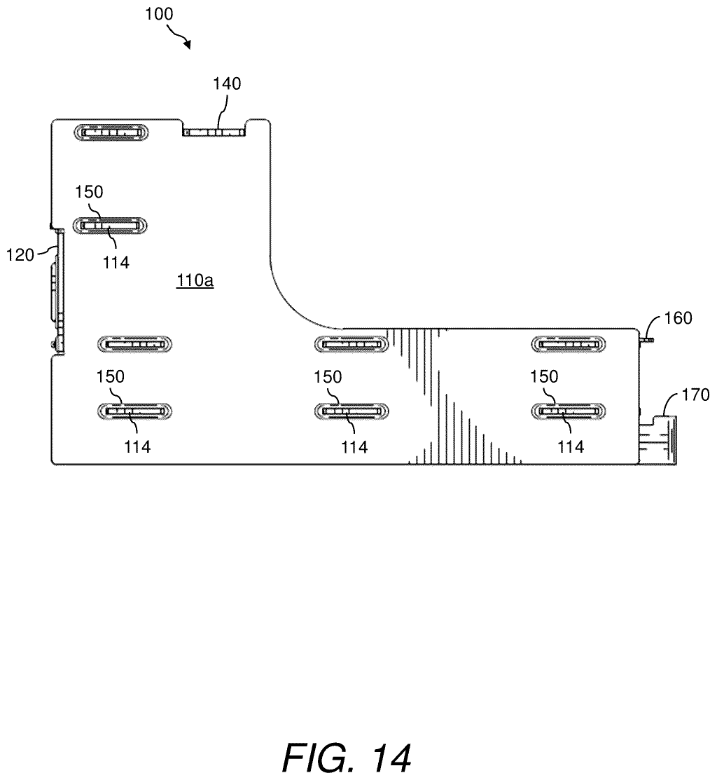

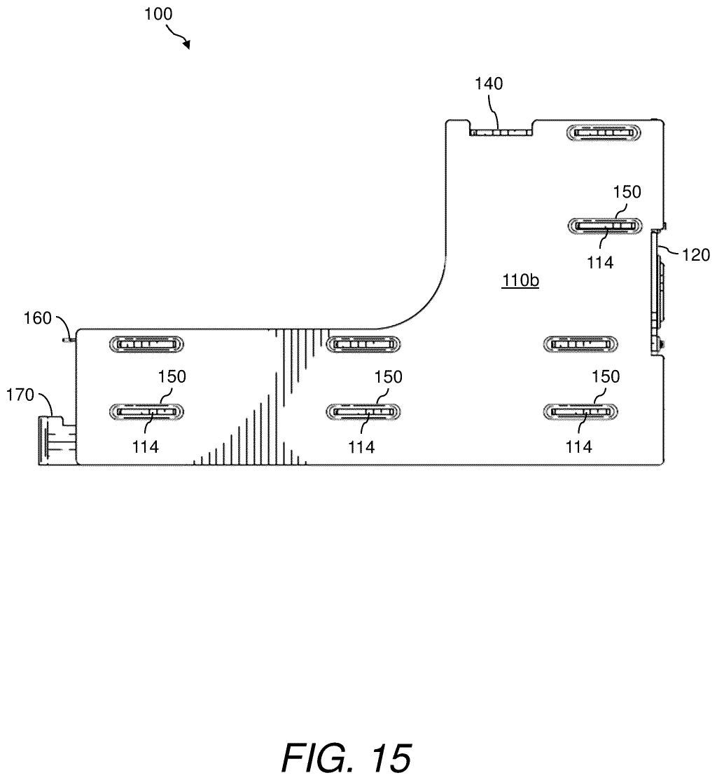

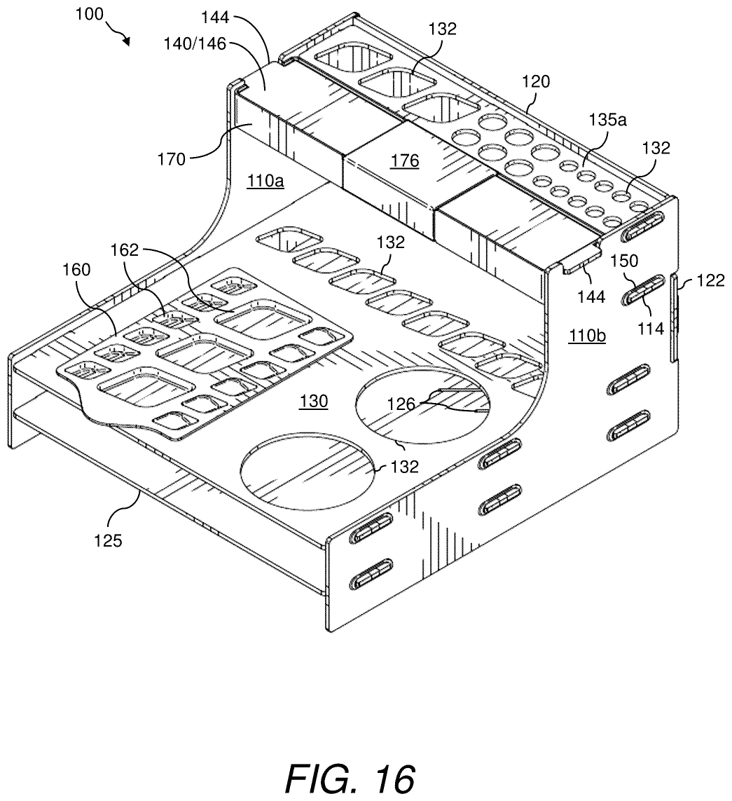

Referring now to FIG. 16 is a perspective view of an example of the art supply storage rack 100 in a “travel” or “storage” configuration, in accordance with an embodiment of the invention. In this example, drip tray 170 may be secured to the underside of the utility tray 140 (with or without the magnetic plate 146 present) using a drip tray band 176 (e.g., an elastic band). Then, together the utility tray 140 holding the drip tray 170 are installed atop the art supply storage rack 100. Namely, the utility tray 140 has two end tabs 144 that sit in upper notches 116 of the two side panels 110.

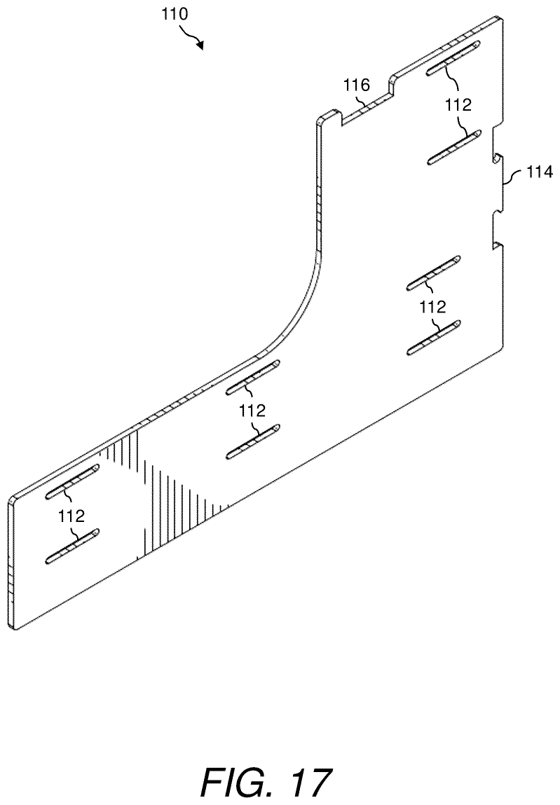

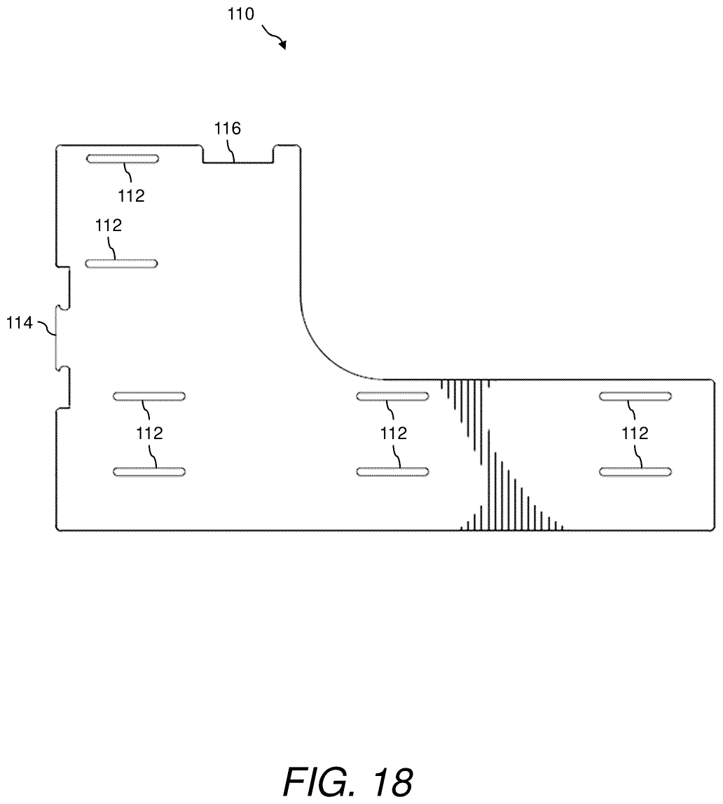

Referring now to FIG. 17 and FIG. 18 is a perspective view and a plan view, respectively, of an example of a side panel 110 of the art supply storage rack 100 shown in FIG. 1. Again, the side panel 110 may include an arrangement of horizontal slots 112, the projecting tab 114, and the upper notch 116 (for receiving the utility tray 140) as shown.

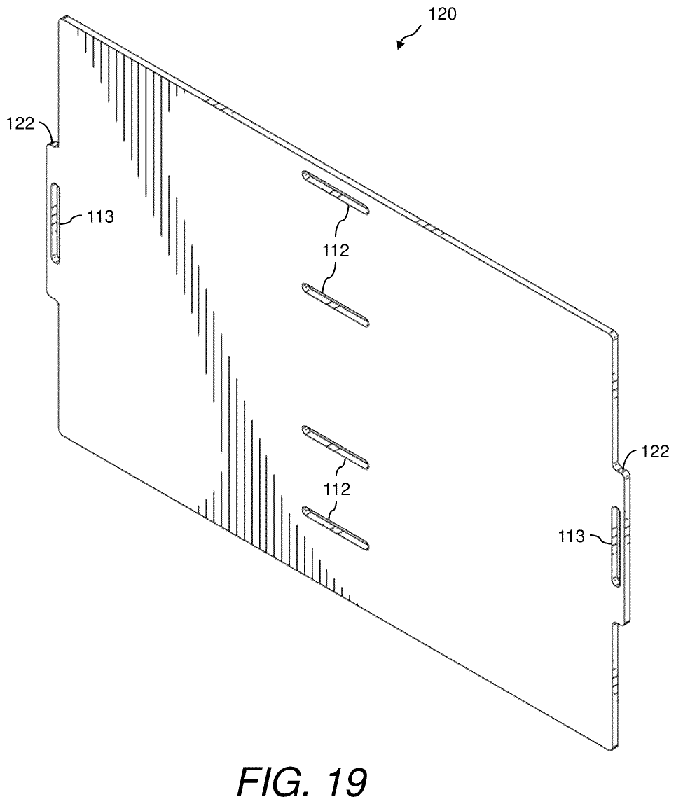

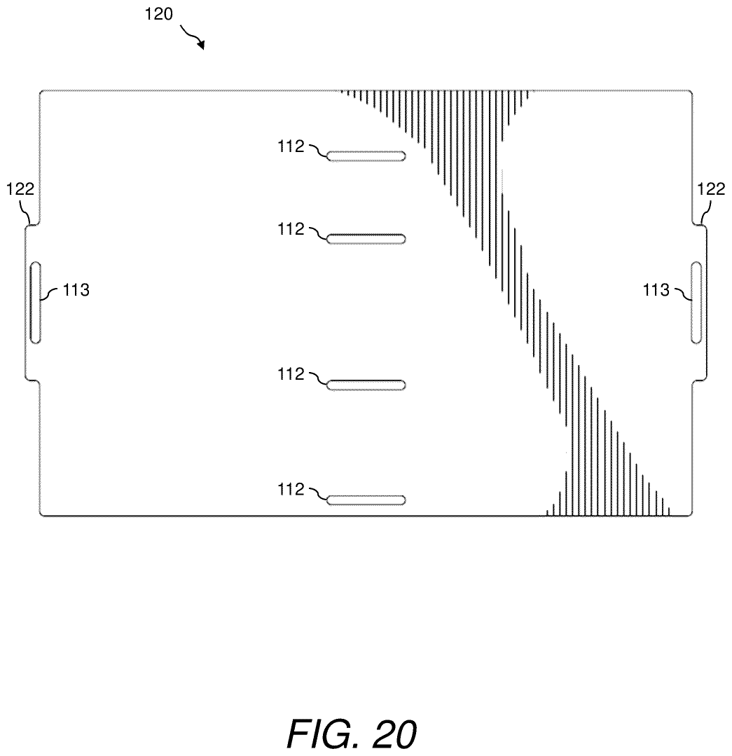

Referring now to FIG. 19 and FIG. 20 is a perspective view and a plan view, respectively, of an example of a back panel 120 of the art supply storage rack 100 shown in FIG. 1. Again, the back panel 120 may include an arrangement of horizontal slots 112 and a tab 122 with a vertical slot 113 on each side as shown.

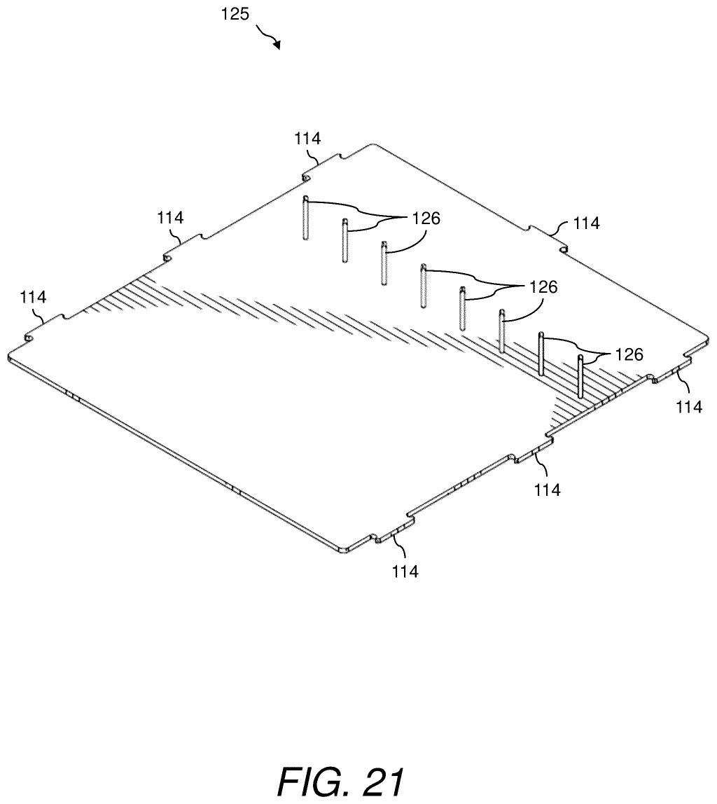

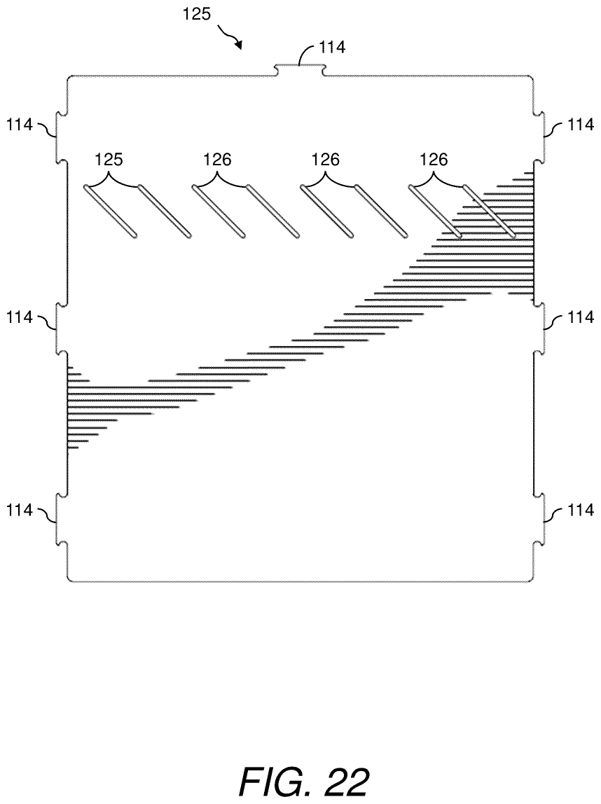

Referring now to FIG. 21 and FIG. 22 is a perspective view and a plan view, respectively, of an example of a horizontal bottom tray 125 of the art supply storage rack 100 shown in FIG. 1. Again, the horizontal bottom tray 125 may include an arrangement of slots 126 as well as projecting tabs 114 on three sides as shown. The slots 126 of the horizontal bottom tray 125 are provided for example, to receive the end portion of paint tubes to help hold the paint tubes in an organized upright position.

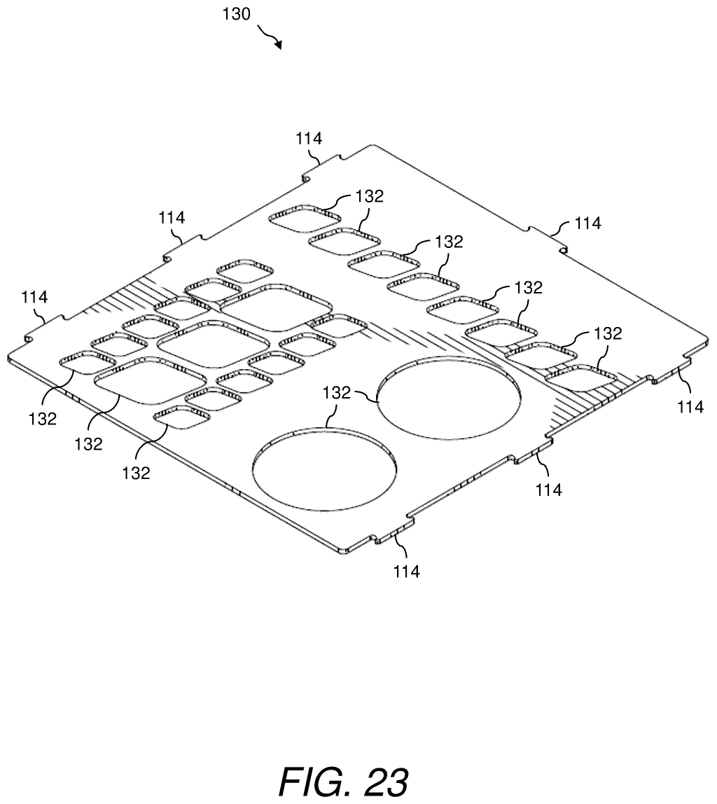

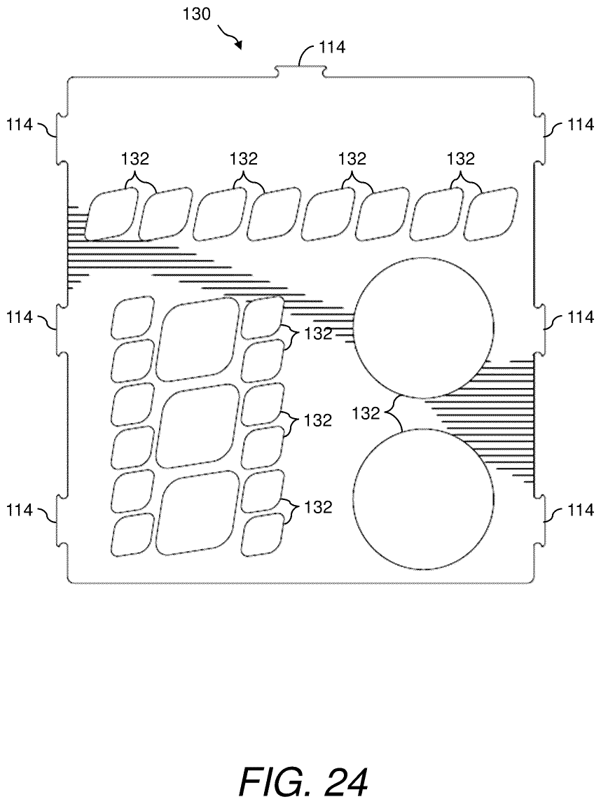

Referring now to FIG. 23 and FIG. 24 is a perspective view and a plan view, respectively, of an example of a horizontal middle tray 130 of the art supply storage rack 100 shown in FIG. 1. Again, the horizontal middle tray 130 may include an arrangement of openings 132 as well as projecting tabs 114 on three sides as shown. Again, the openings 132 can vary is shape, size, location, and/or number. In this example, certain openings 132 may correspond to the features of paint well tray 160. Other openings 132 may be circular openings of various sizes. Yet other openings 132 may be parallelogram-shaped openings of various sizes.

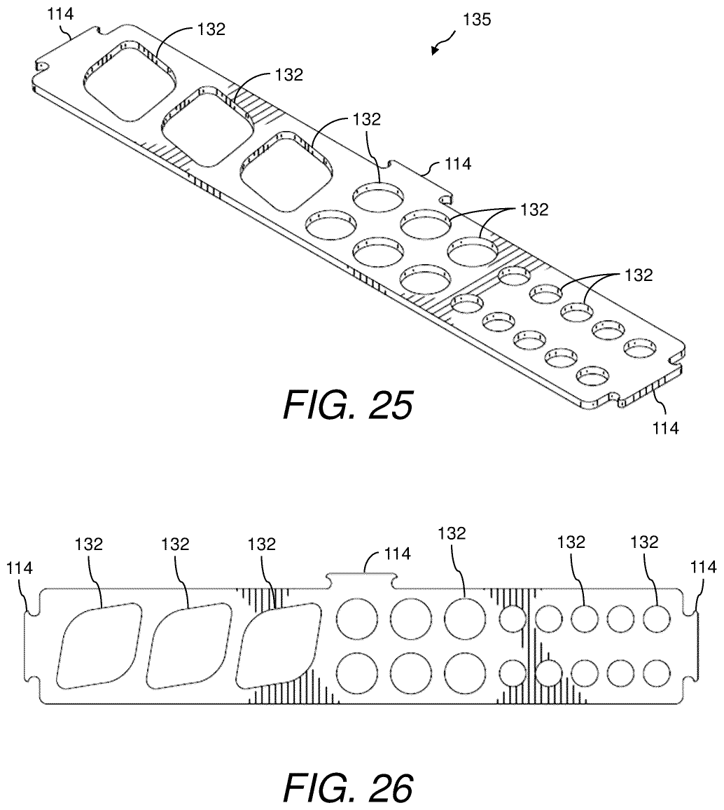

Referring now to FIG. 25 and FIG. 26 is a perspective view and a plan view, respectively, of an example of an upper shelf 135 of the art supply storage rack 100 shown in FIG. 1. Again, the upper shelf 135 may include an arrangement of openings 132 as well as a projecting tab 114 on three sides as shown. Again, the openings 132 can vary is shape, size, location, and/or number.

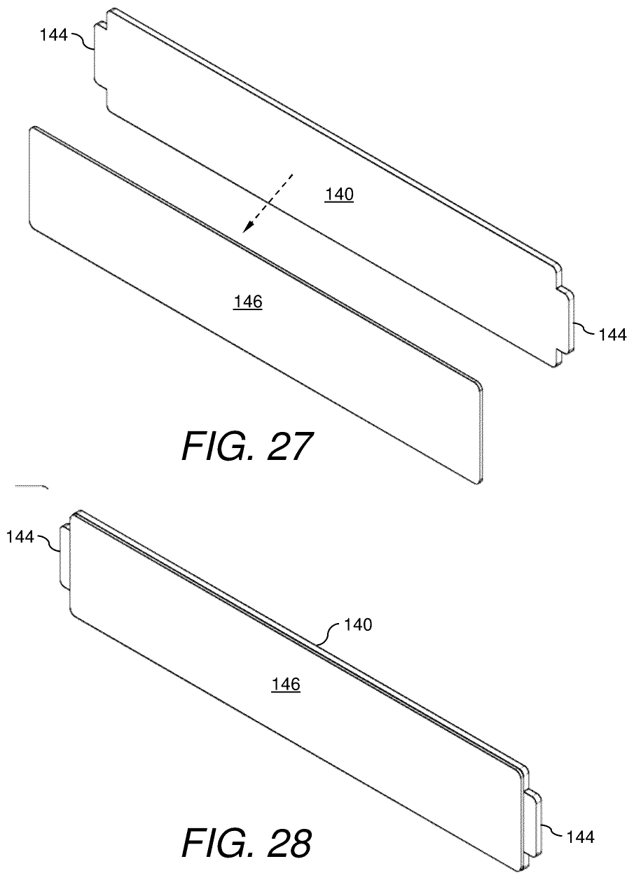

Referring now to FIG. 27 and FIG. 28 is an exploded view and an assembled view, respectively, of an example of the utility tray 140 and the magnetic plate 146 of the art supply storage rack 100 shown in FIG. 1. In this example, the magnetic plate 146 may be adhered to one side of the utility tray 140. When in the “in use” configuration, the utility tray 140 may be oriented with the magnetic plate 146 facing upward, as shown, for example, in FIG. 1 and FIG. 3. However, when in the “travel” or “storage” configuration, the utility tray 140 may be oriented with the magnetic plate 146 facing downward, as shown, for example, in FIG. 40.

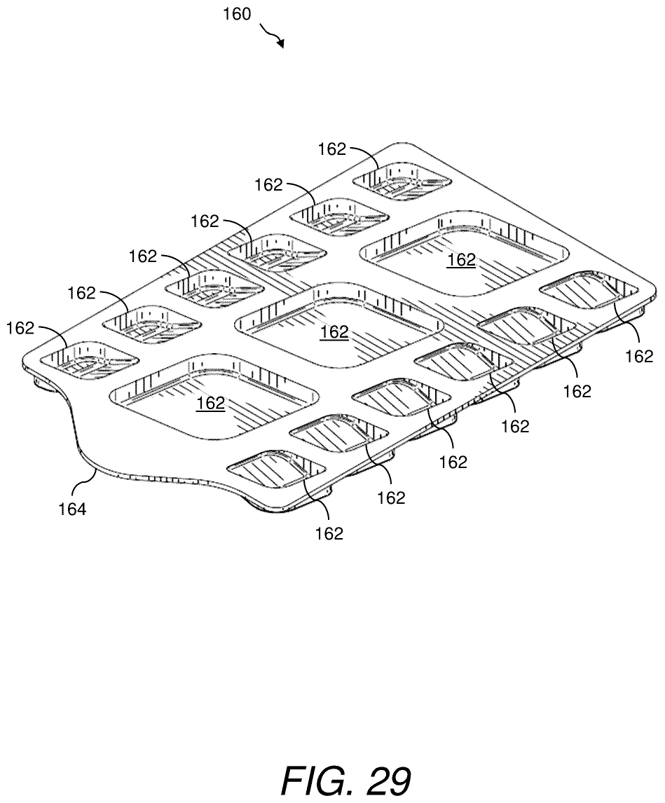

Referring now to FIG. 29 is a perspective view of an example of the paint well tray 160 of the art supply storage rack 100 shown in FIG. 1. Again, the paint well tray 160 provides a multi-well rack for holding an assortment of paint of various different colors. Accordingly, the paint well tray 160 may include an arrangement of reservoirs or compartments 162 for holding paint. The paint well tray 160 may also include a grip handle 164. When the paint well tray 160 sits atop the horizontal middle tray 130, the grip handle 164 projects forward beyond the front edge of the horizontal middle tray 130 for easy grasping, as shown for example in FIG. 1 and FIG. 3.

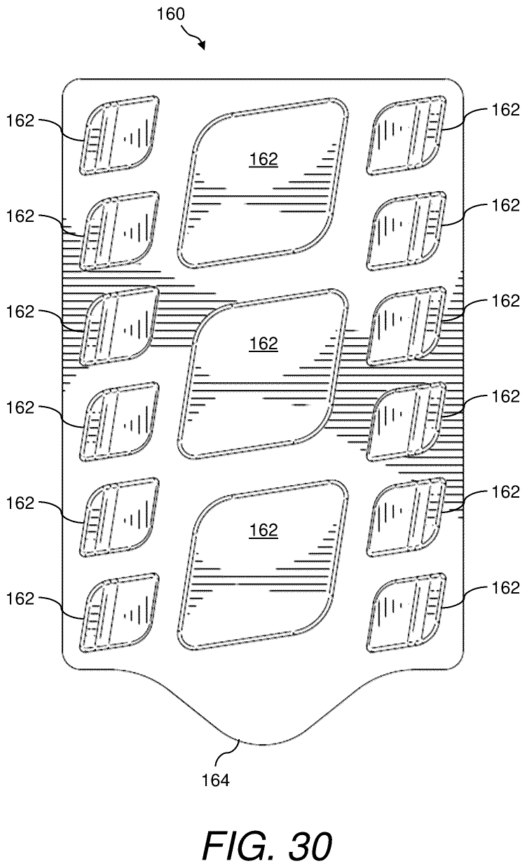

Further, FIG. 30, FIG. 31, FIG. 32, FIG. 33, FIG. 34, and FIG. 35 show a top view, a bottom view, a first end view, a second end view, a first side view, and a second side view, respectively, of the paint well tray 160 shown in FIG. 29.

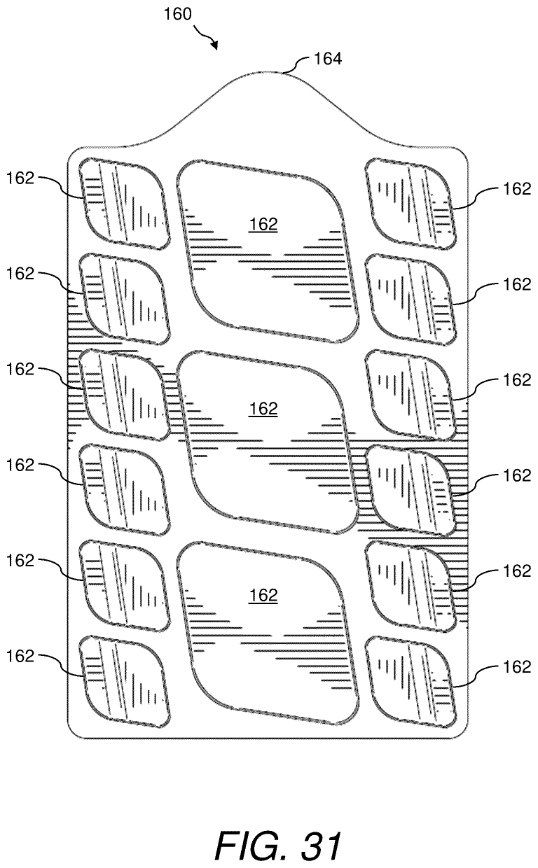

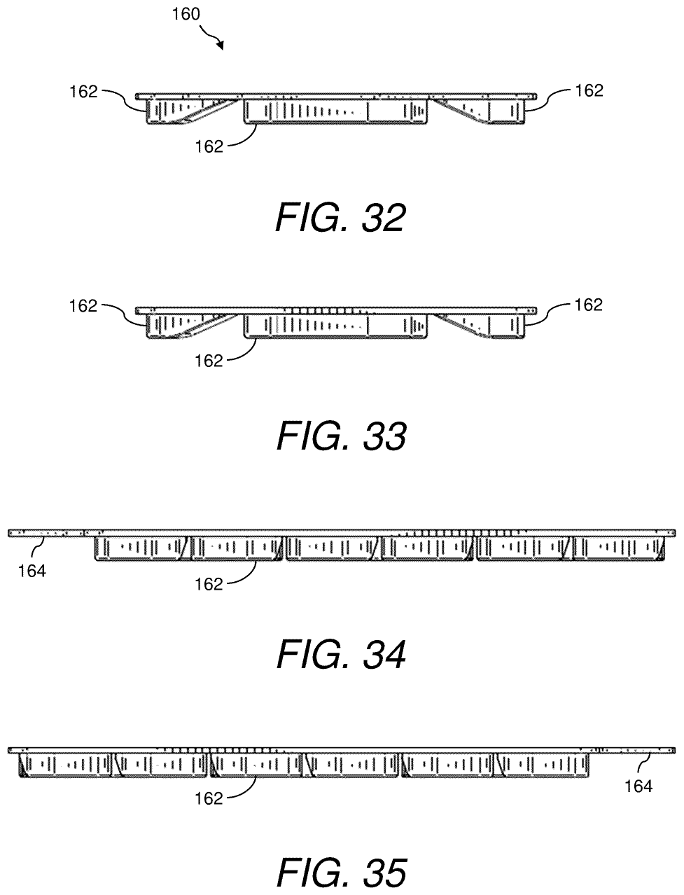

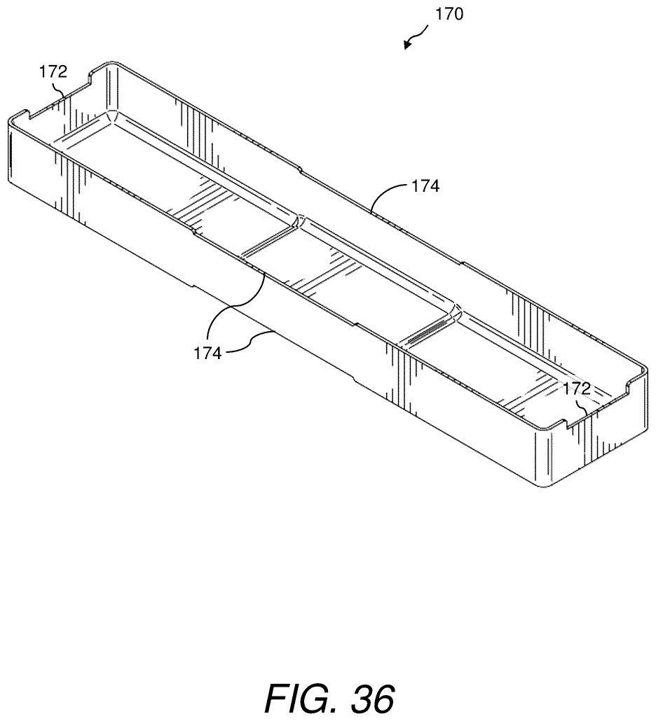

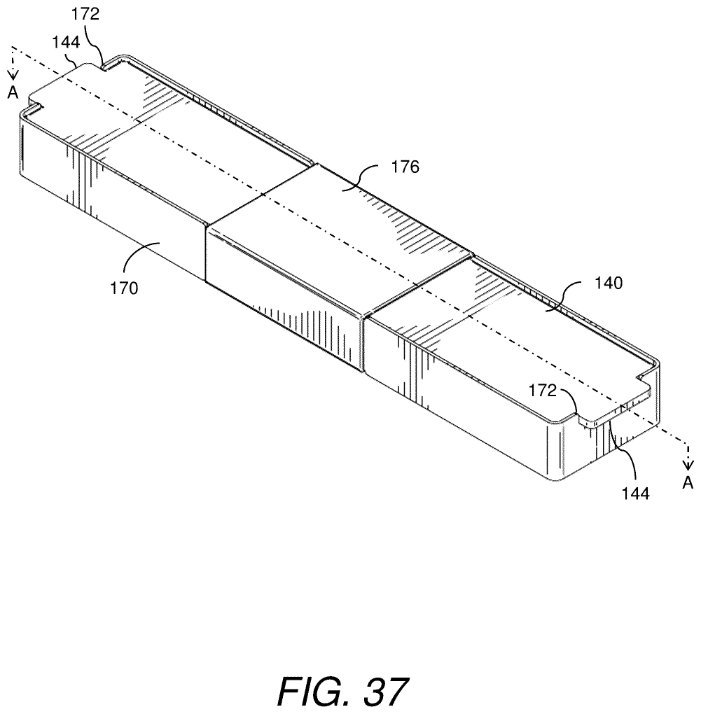

Referring now to FIG. 36 is a perspective view of an example of a drip tray 170 of the art supply storage rack 100 shown in FIG. 1. The drip tray 170 may include end notches 172 for mating to the utility tray 140 in “travel”or “storage”configuration. Further, the drip tray 170 may include side notches 174, which provide a guide for installing the drip tray band 176, again in “travel” or “storage” configuration as shown in FIG. 16 and FIG. 37.

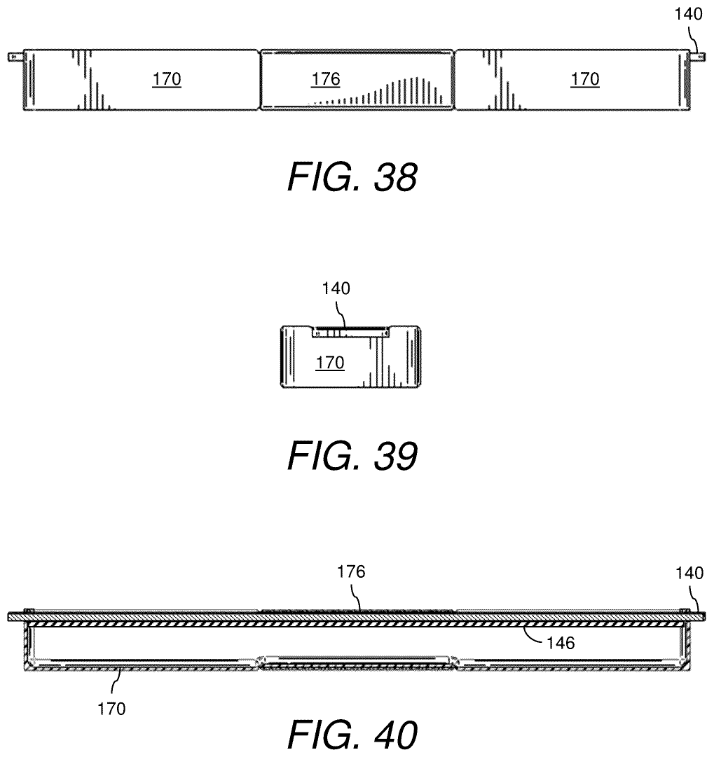

Referring now to FIG. 37, FIG. 38, FIG. 39, and FIG. 40 is a perspective view, a side view, an end view, and a cross-sectional-view, respectively, of an example of the utility tray 140 and the drip tray 170 of the art supply storage rack 100 shown in FIG. 1 in “travel” or “storage” configuration. FIG. 40 is a cross-sectional view taken along line AA of FIG. 37.

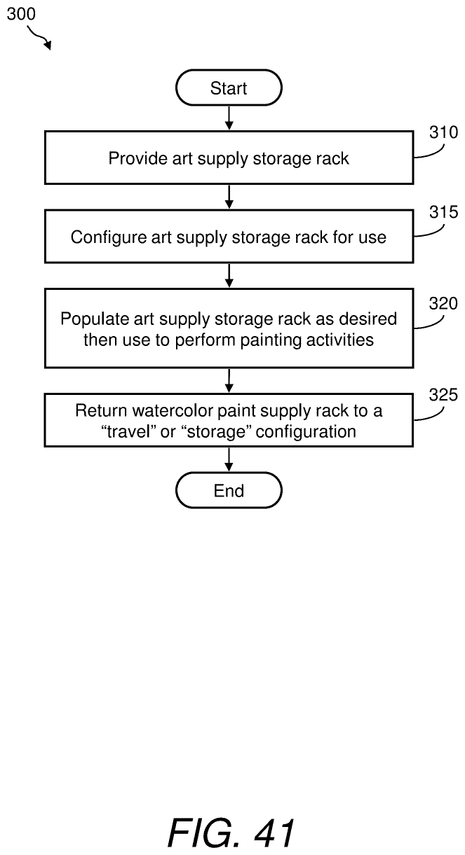

Referring now to FIG. 41 is a flow diagram of an example of a method 300 of using the art supply storage rack 100 shown in FIG. 1 through FIG. 40, in accordance with an embodiment of the invention. Namely, in the method 300, the art supply storage rack 100 is provided for organizing an artist's paint supplies and/or equipment and thereby enhancing the artist's productivity and reducing waste. The method 300 may include, but is not limited to, the following steps.

At a step 310, an art supply storage rack is provided, for example, in a “travel” or “storage” configuration. For example, the art supply storage rack 100 shown and described above in FIG. 1 through FIG. 40 is provided. The art supply storage rack 100 may be provided in the “travel” or “storage” configuration, as shown, for example, in FIG. 16. In this configuration, the drip tray 170 is arranged with the utility tray 140 at the top of the art supply storage rack 100.

At a step 315, the artist may reconfigure the art supply storage rack into an “in use” configuration as desired. For example, the artist may reconfigure the art supply storage rack 100 into an “in use” configuration, as shown, for example, in FIG. 1. In this configuration, the drip tray 170 may be arranged at the bottom of the art supply storage rack 100.

At a step 320, the artist may populate the art supply storage rack as desired and then performs painting activities. For example, the artist may populate the art supply storage rack 100 as desired, as shown, for example, in FIG. 3. Then, the artist may perform painting activities using the art supply storage rack 100.

At a step 325, the artist may return the art supply storage rack into the “travel” or “storage” configuration. For example, upon completion of the painting activities, the artist may return the art supply storage rack 100 into the “travel” or “storage” configuration, as shown, for example, in FIG. 16. That is, the drip tray 170 may be returned to the utility tray 140 at the top of the art supply storage rack 100.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. An art supply storage rack comprising:
a. a first vertical side panel, a second vertical side panel, and a vertical back panel, the first vertical side panel, second vertical side panel, and vertical back panel having one or more tabs and a plurality of slots therein, wherein the tabs of the first vertical side panel, second vertical side panel are configured to insert into corresponding slots of the vertical back panel to define a support frame;
b. a bottom horizontal tray having a plurality of tabs extending outward from opposing side edges and rear edge thereof;
c. a middle horizontal tray having a plurality of spaced openings therethrough and tabs extending outward from opposing side edges and rear edge thereof, the middle horizontal tray configured to be positioned vertically spaced apart from and above the bottom horizontal tray;
d. a first upper horizontal tray having a plurality of spaced openings therethrough and tabs extending outward from opposing side edges and rear edge thereof, the first upper horizontal tray configured to be positioned vertically spaced apart from and above the middle horizontal tray; and
e. wherein, the outwardly extending tabs of each of the bottom horizontal tray, middle horizontal tray, and first upper horizontal shelf are configured to insert into corresponding ones of the slots of the first vertical side panel, second vertical side panel, and vertical back panel to form a rack, and wherein the bottom horizontal tray is configured to be positioned above a bottom of the support frame thereby forming a gap between a bottom surface of the bottom horizontal tray and a surface upon which the rack is set upon.

2. The art supply storage rack of claim 1, wherein a portion of the middle horizontal tray is configured to extend underneath the first upper horizontal shelf.

3. The art supply storage rack of claim 1, further comprising a utility tray having tabs extending outward from opposing side edges thereof, wherein the tabs are configured to engage with an upper notch of each of the first vertical side panel and the second vertical side panel.

4. The art supply storage rack of claim 3, wherein the utility tray is positionable parallel with and within the same horizontal plane as the first upper horizontal shelf.

5. The art supply storage rack of claim 3, wherein the utility tray further comprises a magnetic plate disposed on a surface thereof.

6. The art supply storage rack of claim 3, further comprising a drip tray, wherein the drip tray is configured to be positionable at a front of and/or at least partially within the gap formed below the bottom surface of the bottom horizontal tray.

7. The art supply storage rack of claim 6, wherein the utility tray is configured to be installed on the drip tray, wherein the drip tray comprises end notches formed in an upper rim surface of each end wall of the drip tray, and wherein the tabs of the utility tray are configured to be received by corresponding ones of the end notches of the drip tray.

8. The art supply storage rack of claim 7, wherein the drip tray further comprises side notches formed in each of an upper and lower edge of a portion of each of a front side and a rear side of the drip tray, wherein the side notches are configure to receive a band, and wherein when installed the band is configured to secure the utility tray to the drip tray.

9. The art supply storage rack of claim 7, wherein the utility tray with the drip tray secured thereto is configured to be received by the upper notches of each of the first vertical side panel and the second vertical side panel via overhanging portions of the tabs extending outward from opposing side edges of the utility tray and drip tray.

10. The art supply storage rack of claim 1, further comprising a removable paint well tray, the paint well tray comprising a plurality of paint wells.

11. The art supply storage rack of claim 10, wherein the middle horizontal tray is configured to receive the paint well tray.

12. The art supply storage rack of claim 11, wherein certain ones of the spaced openings of the middle horizontal tray are configured to receive well portions of the paint wells of the paint well tray therein.

13. The art supply storage rack of claim 1, wherein at least one elastic band surrounds a portion of at least one respective tab that extends through the slot it is inserted into to secure the frame and/or rack in place.

14. The art supply storage rack of claim 1, wherein one or more of the spaced openings of the middle horizontal tray and first upper horizontal shelf are configured to receive at least one or more of paint tubes and paintbrushes.

15. The art supply storage rack of claim 14, wherein the bottom horizontal tray includes a plurality of spaced slots therein, and wherein one or more of the spaced openings are positioned and configured such that a sealed end of a paint tube is guided toward one of the slots of the bottom horizontal tray when the paint tube is inserted therein.

16. The art supply storage rack of claim 1, wherein one or more of the spaced openings are different sizes of one or more of other spaced openings to accommodate variously sized paint tubes and/or paintbrushes.

17. The art supply storage rack of claim 1, further comprising a second upper horizontal shelf having a plurality of spaced openings therethrough and tabs extending outward from opposing side edges and rear edge thereof, the second upper horizontal tray configured to be positioned vertically spaced apart from and above the middle horizontal tray and below the first upper horizontal tray wherein, the outwardly extending tabs of the second upper horizontal shelf are configured to insert into slots of the first vertical side panel, second vertical side panel, and vertical back panel.

18. The art supply storage rack of claim 17, wherein one or more of the spaced openings of the middle horizontal tray, first upper horizontal shelf, and second upper horizontal shelf are configured to receive at least one or more of paint tubes and paintbrushes.

19. The art supply storage rack of claim 17, wherein one or more of the spaced openings of the second horizontal tray mirror respective ones of one or more of the spaced openings of the first upper horizontal shelf.

20. The art supply storage rack of claim 17, wherein one or more of the spaced openings are different sizes of one or more of other spaced openings to accommodate variously sized paint tubes and/or paintbrushes.

21. A method of using an art supply storage rack, the method comprising:
a. providing the art supply storage rack, the art supply rack comprises:
i. a first vertical side panel, a second vertical side panel, and a vertical back panel, the first vertical side panel, second vertical side panel, and vertical back panel having one or more tabs and a plurality of slots therein, wherein the tabs of the first vertical side panel, second vertical side panel are configured to insert into corresponding slots of the vertical back panel to define a support frame;
ii. a bottom horizontal tray having a plurality of tabs extending outward from opposing side edges and rear edge thereof;
iii. a middle horizontal tray having a plurality of spaced openings therethrough and tabs extending outward from opposing side edges and rear edge thereof, the middle horizontal tray configured to be positioned vertically spaced apart from and above the bottom horizontal tray;
iv. a first upper horizontal tray having a plurality of spaced openings therethrough and tabs extending outward from opposing side edges and rear edge thereof, the first upper horizontal tray configured to be positioned vertically spaced apart from and above the middle horizontal tray; and
v. wherein, the outwardly extending tabs of each of the bottom horizontal tray, middle horizontal tray, and first upper horizontal shelf are configured to insert into corresponding ones of the slots of the first vertical side panel, second vertical side panel, and vertical back panel to form a rack, and wherein the bottom horizontal tray is configured to be positioned above a bottom of the support frame thereby forming a gap between a bottom surface of the bottom horizontal tray and a surface upon which the rack is set upon.
b. configuring the art supply storage rack for use;
c. stocking the art supply storage rack with desired art supplies to conduct an art activity; and
d. optionally, at a conclusion of the art activity, configuring the art supply storage rack to a storage or travel configuration.
